(19) United States
(12) Patent Application Publication
(10) Pub. No.: US 2021/0214185 A1
(43) Pub. Date: Jul. 15, 2021

(54) INTERFACE DEVICE, AN ELEVATOR SYSTEM, AND A METHOD FOR CONTROLLING OF DISPLAYING OF A PLURALITY OF DESTINATION CALLS

(71) Applicant: KONE Corporation, Helsinki (FI)

(72) Inventors: Jussi HILTUNEN, HELSINKI (FI); Reetta RANNE, HELSINKI (FI); Ari KOIVISTO, HELSINKI (FI); Jesse TERTSUNEN, HELSINKI (FI)

(73) Assignee: KONE Corporation, HELSINKI (FI)

(21) Appl. No.: 17/215,549

(22) Filed: Mar. 29, 2021

Related U.S. Application Data
(63) Continuation of application No. PCT/FI2018/050747, filed on Oct. 16, 2018.

(51) Int. Cl. B66B 1/46; B66B 3/00

(52) U.S. Cl. CPC B66B 1/468; B66B 2201/4615; B66B 2201/103; B66B 3/006

(57) ABSTRACT

An interface device for controlling displaying of a plurality of destination calls includes an input configured to receive user input for making one or more destination calls, a controller entity configured to record made destination calls, and at least one display capable of displaying simultaneously a pre-determined number of destination calls. The predetermined number is two or more. The at least one display is configured to display simultaneously the predetermined number of most recent destination calls made from said interface device. An elevator system and a method for controlling displaying of a plurality of destination calls include the interface device.

### TECHNICAL FIELD

The invention concerns in general the technical field of elevators. Especially the invention concerns destination calls of elevators.

### BACKGROUND

Typically, an elevator system comprises an interface device, e.g. a destination operation panel (DOP) for providing a destination call to a desired destination floor, which may be predefined or manually chosen. Often each destination call may have a passenger specific ID associated to it. The passenger may show an access device, such as an access card, ID card or similar device, to the interface device in order to provide a destination call to the desired destination floor. Alternatively, the destination call to the desired destination floor may be provided with any other device capable for providing the destination call, such as turnstile or mobile device.

The elevator allocated for the destination call may be displayed on a display of the interface device immediately after generation of the destination call during a predetermined time, such as 2 to 5 seconds. It is straightforward to understand that almost always this slows down the flow of passengers especially during rush hours, because the following passenger needs to wait for the guidance of the previous passenger to finish before making a destination call. According to one prior art solution by touching the touch screen of the interface device the passenger may exit the guidance of the previous passenger in order to proceed with own destination call giving process.

Hence, there is need to develop further solutions in order to improve the efficiency of an elevator system.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An objective of the invention is to present a method, an interface device, and a system for controlling displaying of a plurality of destination calls. Another objective of the invention is that the method, the interface device, and the system controlling displaying of a plurality of destination calls improves at least partly the efficiency of an elevator system.

The objectives of the invention are reached by a method, an interface device, and a system as defined by the respective independent claims.

According to a first aspect, an interface device for controlling displaying of a plurality of destination calls is provided, wherein the device comprises: input means configured to receive user input for making one or more destination calls, a controller entity configured to record made destination calls, and at least one display capable of displaying simultaneously a pre-determined number of destination calls, wherein the predetermined number is two or more, wherein the at least one display is configured to display simultaneously said predetermined number of most recent destination calls made from said interface device.

The displayed destination call may comprise a destination floor.

Furthermore, the displayed destination call may further comprise departure floor and/or state of the destination call.

Furthermore, the controller entity may further be configured to: generate a control signal to a computing entity for allocating an elevator to the made destination call, and receive the allocation information of the made destination call, wherein the displayed made destination call may further comprise allocation information of the destination call.

The allocation information may comprise an elevator ID of the elevator currently allocated to the destination call, and/or guidance to the elevator currently allocated to the destination call.

The computing entity may be an elevator controller entity, the controller entity of the interface device, or any dedicated locally or remotely arranged device.

The interface device may be a destination operation panel, DOP.

The at least one display may be implemented as a dynamic header element.

The input means may be at least one of the following: a card reader, RFID reader, QR code reader, a facial recognition camera, keypad, touch screen, a microphone for voice control, a camera for gesture control.

The input means may be implemented as an external entity of the interface device communicatively coupled to the interface device.

The user input may further comprise an instruction for cancelling the most recent destination call and the controller entity may be configured to cancel the recorded most recent destination call.

Alternatively or in addition, the input means may further be configured to receive further user input comprising the passenger ID, the controller entity may be configured to retrieve from a memory unit of the controller entity already made destination call corresponding to the passenger ID of the received user input, and the at least on display may be configured to display the destination call corresponding to the passenger ID of the received user input simultaneously with other destination call, if the destination call is among said predetermined number of most recent destination calls.

According to a second aspect, an elevator system is provided, wherein the elevator system comprising: at least one elevator, a computing entity, and at least one interface device described above.

According to a third aspect, a method for controlling displaying of a plurality of destination calls is provided, wherein the method comprising: receiving, by input means, user input for making one or more destination calls; recording, by a controller entity, made destination calls; and displaying, by at least one display capable of displaying simultaneously a predetermined number of destination calls, simultaneously said predetermined number of most recent destination calls, wherein the predetermined number is two or more.

The displayed destination call may comprise a destination floor.

Furthermore, the displayed destination call may further comprise departure floor and/or state of the destination call.

The method may further comprise: generating, by the controller entity, a control signal to a computing entity for allocating an elevator to the made destination call; and receiving, by the controller entity, the allocation information of the made destination call, wherein the displayed made destination call may further comprise allocation information of the destination call.

The allocation information may comprise an elevator ID, and/or guidance to the elevator, an elevator ID of the elevator currently allocated to the destination call, and/or guidance to the elevator currently allocated to the destination call.

The method may further comprise: receiving, by the input means, user input comprising an instruction for cancelling the most recent destination call; and cancelling, by the controller entity, the recorded most recent destination call.

Alternatively or in addition, the method may further comprise: receiving, by the input means, further user input comprising the passenger ID; retrieve, by the controller entity, already made destination call corresponding to the passenger ID of the received user input; and displaying, by the at least on display, the destination call corresponding to the passenger ID of the received user input simultaneously with other destination calls, if the destination call is among said predetermined number of most recent destination calls.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an example of an elevator system according to an embodiment of the invention.

FIG. 2 schematically illustrates an example of entities of an interface device according to an embodiment of the invention.

FIG. 3 illustrates an example of a controller entity of an interface device according to an embodiment of the invention.

FIG. 4A illustrates an example of a method according to an embodiment of the invention.

FIG. 4B illustrates another example of a method according to an embodiment of the invention.

FIGS. 5A-5C illustrates examples of an interface device according to an embodiment of the invention.

FIG. 6 illustrates another example of an interface device according to an embodiment of the invention.

FIG. 7 illustrates an example of an elevator controller entity according to an embodiment of the invention.

### DESCRIPTION OF THE EXEMPLIFYING EMBODIMENTS

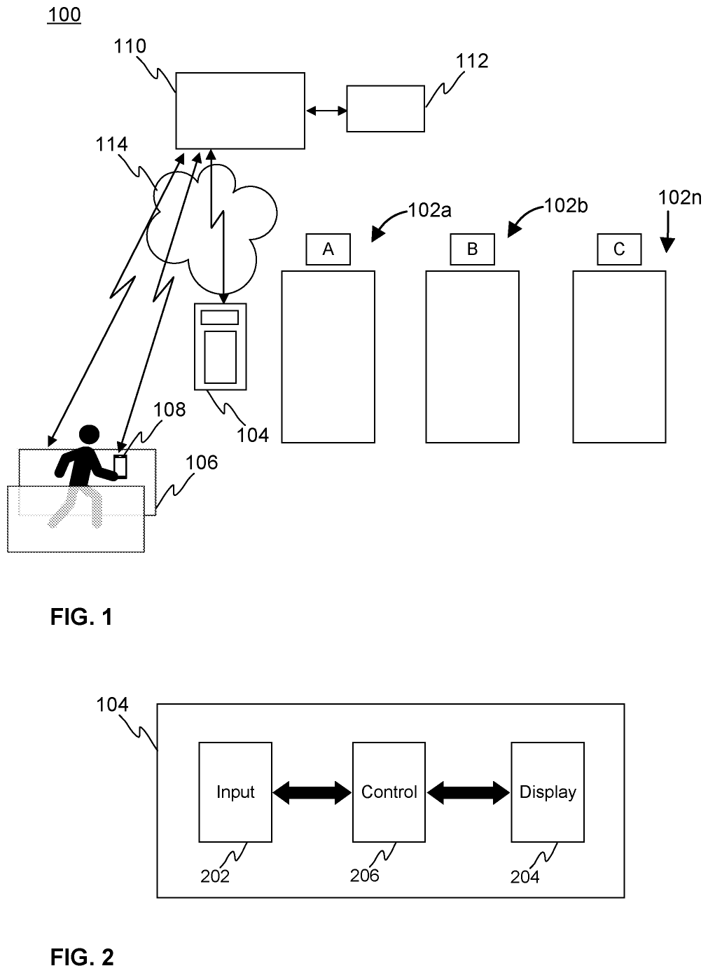

FIG. 1 schematically illustrates an example of an elevator system 100 comprising one or more elevators 102a-102n residing in a location, e.g. in a building or in a ship (for sake of clarity the elevator shafts of the elevators are not shown in FIG. 1). The elevator system 100 comprises one or more interface devices 104, e.g. a destination operation panel (DOP), for providing a destination call to a desired destination floor, which may be predefined or manually chosen. The one or more interface devices 104 may be located for example at an elevator lobby of each floor of the location in which the elevator system 100 is arranged. Each interface device 104 may comprise a user interface and a controller entity 206 for controlling at least partly the operation of the interface device 104. The user interface may comprise input means 202, i.e. one or more input devices, and at least one display 204 for interacting with at least one user, i.e. passenger. However, the present invention is not limited to destination calls made by the one or more interface devices 104, but the destination call to the desired destination floor may be provided with any other destination call devices capable for making a destination call, such as one or more turnstiles 106 or one or more mobile devices 108.

The elevator system 100 further comprises an elevator controller entity 110 configured to control at least elevator entities 112 of the elevator system 100. For example, the elevator entities may comprise, but are not limited to, drive circuit and devices, safety circuit and devices, sensors, elevator door circuits and devices, elevator cabin and similar. The elevator entities 112 are at least communicatively coupled to each other either directly or indirectly e.g. through the elevator controller entity 110, which operates as a master device for the elevator 102a-102n.

The elevator controller entity 110 and the one or more interface devices 104 may be communicatively coupled to each other e.g. over a communication network 114. The communication network 114 may implement a wired or a wireless communication technology. The communication network 114 may e.g. be a mobile communication network or a local communication network. The elevator controller entity 110 comprises a communication interface, such a modem implementing the communication technology in use, towards the communication network 114. Similarly, the one or more interface devices 104 is configured accordingly to communicate through the communication network 114.

FIG. 2 schematically illustrates an example of entities of the interface device 104, e.g. a DOP, according to an embodiment. As discussed above the interface device 104 may comprise input means 202, at least one display 204, and a controller entity 206. The input means 202 may comprise at least one of the following: a card reader, RFID reader, NFC reader, QR code reader, a facial recognition camera, keypad, touch screen, a microphone for voice control, at least one camera for gesture control.

The input means 202 may interact with the at least one user, e.g. receive user input, through an access device, e.g. an access card, ID card, key card, mobile device, etc., comprising at least one of the following (respective to the input means of the interface device): RFID tag, NFC tag, QR code. Alternatively or in addition, the interaction with the at least one user may be provided so that the user press or touches the keypad and/or the touch screen in order to provide the user input. Alternatively or in addition, the interaction with the at least one user may be based on facial recognition and the facial recognition camera of the interface device 104 may be configured to provide image data, e.g. still or video, from the face of the passenger in order to provide user input for making a destination call, e.g. the face of the passenger may be used as a passenger ID. The controller entity 206 may be configured to perform facial recognition, i.e. process the received image data, e.g. by analyzing the received image data to identify the passenger. Alternatively or in addition, interaction with the at least one user may be based on voice control and the microphone may be configured to receive one or more voice commands given by the at least one passenger in order to provide user input for making a destination call, for example the voice command may comprise the destination floor, passenger ID, etc. The controller entity 206 may be configured to perform voice recognition or speech recognition, i.e. process the received voice commands, e.g. by converting the analog voice commands to digital signals, interpreting the signals etc. Alternatively or in addition, interaction with the at least one user may be based on gesture control and the at least one camera for the gesture control may be configured to provide image data, e.g. still or video, from the passenger in order to provide user input for making a destination call, for example a gesture of the passenger may correspond to a specific user input, e.g. destination floor, passenger ID etc. The controller entity 206 may be configured to perform gesture recognition, i.e. process the received image data, e.g. by analyzing the received image data to interpret the gesture of the passenger.

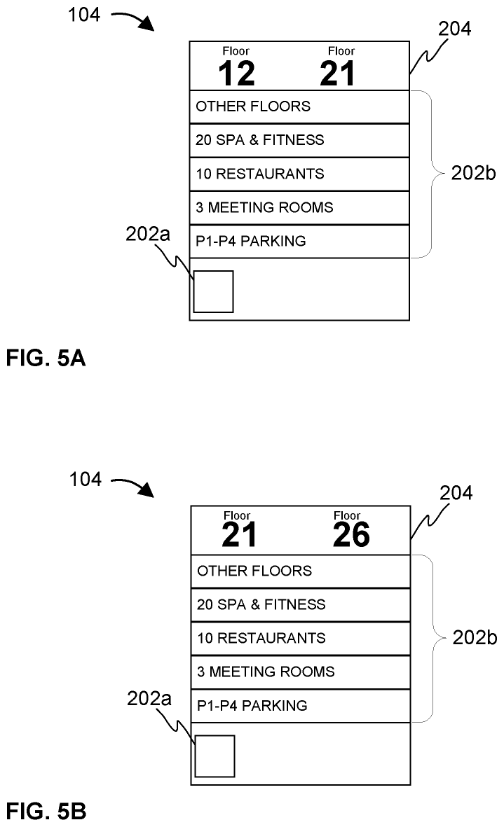

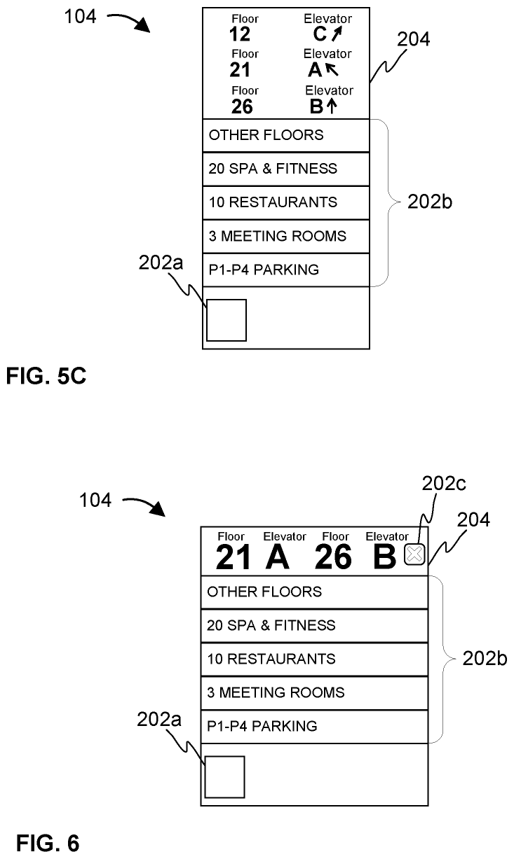

The input means 202 may be implemented as an internal entity of the interface 104 as it is illustrated in FIGS. 5A-5C and 6. Alternatively or in addition, the input means 202 may be implemented as an external entity of the interface device 104 communicatively coupled to the interface device 104, wherein the communicatively coupling may be based on one or more known communication technologies, either wired or wireless. For example, if the input means 202 comprises facial recognition camera, the camera may be external entity of the interface device arranged a location capable to perform facial recognition.

The at least one display 204 of the interface device 104 may be implemented as a dynamic header element. However, the at least one display 204 may be located anywhere of the interface device 104, preferably at the side facing to the passengers when the interface device 104 is arranged for example to an elevator lobby in the location. According to one embodiment the at least one display 204 and the input means 202 may be implemented as a common touch screen. The at least one display 204 is capable of displaying simultaneously a predetermined number of destination calls, wherein the predetermined number is two or more.

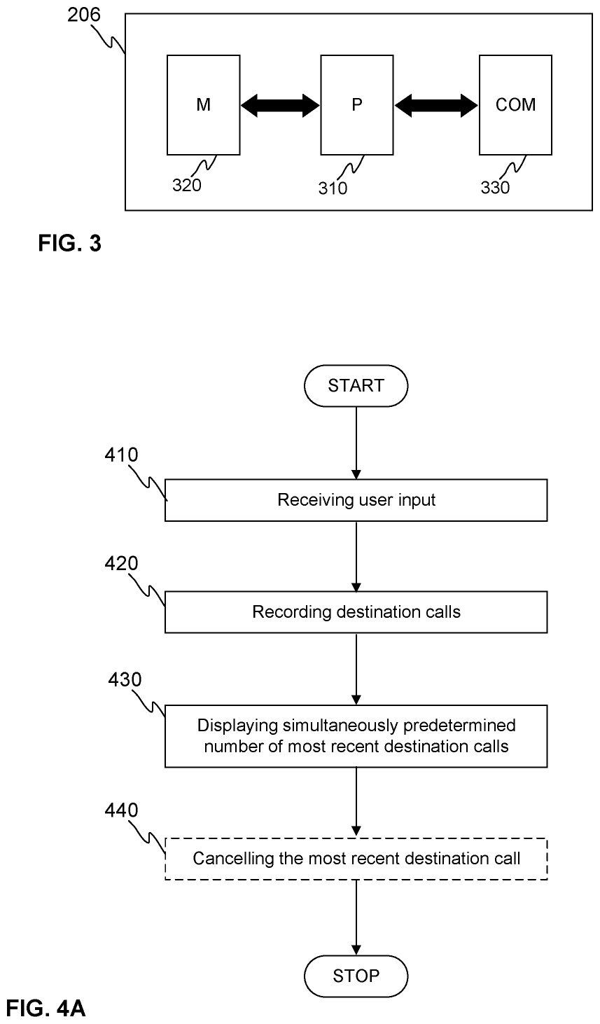

FIG. 3 illustrates schematically an example of the controller entity 206 of the interface device 104 according to an embodiment of the invention. The controller entity 206 may comprise at least the following entities: processing unit 310 comprising one or more processors, memory unit 320 comprising one or more memories, and communication unit 330 comprising one or more communication devices, such as modems. In addition to the mentioned entities the controller entity 206 may comprise further devices and entities, such as batteries for storing energy to be used by the other entities. The entities of the controller entity 206 of the interface device 104 may be communicatively coupled to each other with e.g. a communication bus. The processing unit 310 may be configured to control the operation of interface device 104 by executing portions of computer program code stored e.g. in the memory unit 320. The memory unit 320 may also be used for storing retrieved and received information together with any other data either permanently or temporarily. Furthermore, the processing unit 310 may be configured to control communication with any external entity, such as with a computing entity, an elevator controller 110, one or more turnstiles 106, one or mobile devices 108, one or more other interface devices, or any other entities.

Moreover, the communication unit 330 may comprise a communication interface though which the interface device 104 may be communicatively coupled to a computing entity, such as an elevator controller entity 110, to another interface device and/or any other devices. The communication between the interface device 104 and the mentioned entities may e.g. be arranged through the communication network 114. Alternatively or in addition, the interface device 104 may be configured to communicate with at least one of the mentioned entities locally e.g. over a short range wireless communication technology. For example, the interface device 104 and the other entities may be coupled to a local Wi-Fi network and the communication may be arranged over it. According to still further embodiment a dedicated communication channel may be arranged between the interface device 104 and the other entities.

The interface device 104 may be mounted to a wall at the elevator lobby in the location in which the elevator system 100 is arranged. Alternatively, the interface device 104 may comprise a pedestal that may be arranged on a floor of the elevator lobby. The pedestal may be fixed to the floor or it may be movable.

Next some non-limiting examples of making destination calls are introduced. According to one example the destination call may be made by means of the one or more interface devices 104. The input means 202 of the interface device 104 may be configured to receive user input comprising destination floor and/or a passenger ID for making a destination call.

The destination floor may be predefined, i.e. included in the received user input or stored to the computing entity that is configured to allocate an elevator to the made destination calls or stored to the controller entity 206 of the interface device 104. In case the destination floor is stored to the computing entity or to the controller entity 206 of the interface device 104, the received user input comprises the passenger ID to identify the passenger and for each passenger ID respective destination floor is prestored to the computing entity to the controller entity 206. Alternatively or in addition, the destination floor may be manually chosen by the passenger via the input means.

The input means 202 may comprise a reader, e.g. RFID reader, NFC reader, or QR code reader, that may interact with an access card that comprises a corresponding tag, e.g. RFID tag, NFC tag, or QR code, in order to receive user input for making a destination call. Alternatively or in addition, the interface device 104 may comprise any other type input means 202 as discussed above and correspondingly the access device may be any other type of access device as discussed above. The passenger may make a destination call by showing the access card to the reader of the interface device 104. The interface device 104 may further comprise a touch screen configured to receive user input for making a destination call. For example, the passenger may touch the touch screen on the area indicating one of the floors, in order to make a destination call to said floor. In response to receiving the user input by the input means 202 the controller entity 204 of the interface device 104 is configured to record the made destination call, i.e. made destination call is stored into the memory unit 320 of the controller entity 204. Furthermore, the controller entity 206 may be configured to provide the input information to the computing entity for allocating an elevator to the made destination call. In case of a delayed destination call system (delayed DCS) an allocation of an elevator to the made destination call may be performed or postponed later or may be re-performed, re-optimized or updated later. The allocation information may or may not be shown to the passenger by at least one display 204 of the interface device 104.

According to another example, the user may use a mobile device 108, e.g. mobile phone, tablet computer, to make the destination call to a desired destination floor. The mobile device 108 may comprise e.g. a mobile application through which the user may select the destination floor in order to make a destination call to said floor. The mobile device 108 may be communicatively coupled to a computing entity may e.g. over a communication network 114 for making the destination call. The communication network 114 may e.g. be a mobile communication network.

According to another example, the passenger may show an access device to the turnstile 106 communicatively coupled to a computing entity over a communication network 114 in order to provide a destination call to the desired destination floor. The turnstile 106 may be located for example at an elevator lobby or at a corridor in the vicinity of the elevator 102a-102n of the location, e.g. in a building or in a ship, wherein the elevator system 100 locates.

According to yet another example, in case the access device comprises a tag for a short-range wireless communication, such as RFID tag, the passenger does not have to show the access device to the interface device 104 and/or to the turnstile 106 in order to make the destination call, the passenger may just walk through the turnstile 106 or pass by the interface device 104 at such a distance that is within a read range, i.e. the distance from which a tag may be read, of the corresponding short-range wireless communication reader, such as RFID reader, of the interface device 104 to make the destination call.

The destination call made from any of the above discussed destination call devices may be provided to the computing entity that is configured to allocate an elevator to the made destination call. The destination call may be provided to the computing entity for example by generating a control signal to the computing entity for allocating an elevator to the made destination call. The allocation of an elevator may be performed immediately after receiving user input for making the destination call or the allocation of an elevator to the made destination call may be performed or postponed later. Alternatively or in addition, the allocation of an elevator may be re-performed, re-optimized or updated later, e.g. if another elevator car is defined to be more appropriate, e.g. quicker, less stops on other floors, etc., to serve the passenger at the time when the passenger arrives to said elevator. The computing entity may further be configured to control the allocation information of the made destination calls. The controlling of the allocation information of the made destination calls may comprise for example storing of the allocation information of the made destination calls, cancelling of the allocation of the made destination calls, sending the allocation information of the made destination calls to any other entity, etc. The destination call provided to the computing entity may comprise a destination floor, location of the destination call device, and/or a passenger ID. In response to allocation of the elevator to the destination call, the computing entity is configured to send the allocation information of the destination call to the destination call device from which the destination call is made. The allocation information of the destination call may comprise the destination floor, the elevator ID of the elevator 102a-102n currently allocated to the destination call, and/or guidance to the elevator currently allocated to the destination call. Alternatively or in addition, the computing entity may be configured to send the allocation information of the destination call to another destination call device than the device from which the destination call is provided. For example, if the destination call is made from a mobile device 108, the computing entity may be configured to send the allocation information of the destination call to said mobile device 108 and/or to one or more interface devices 104 of the elevator system 100.

In case an access control is required for the passenger to enter the desired destination floor, the computing entity may further be implemented as an access control entity and configured to identify the passenger by means of the passenger ID before allocating the destination call. The access control entity may be configured to store a plurality of passenger IDs that have access to one or more floors in the location. The identification of the user by means of the passenger ID may be provided so that the access control entity is configured to check whether the received passenger ID corresponds to one of the plurality of passenger IDs stored into the access control entity. In response to positive identification result, i.e. the access is approved, the computing entity is configured to allocate an elevator to the made destination call and possibly further provide an acknowledge signal to the destination call device indicating that the access is approved. Alternatively, in response to a negative identification result, i.e. the access is denied, the computing entity may be configured to provide an acknowledge signal to the destination call device indicating that the access is denied. The destination call device may then be configured to indicate the identification result to the user by means of one or more output means, such as one or more display, one or more light, a speaker etc.

The computing entity may be for example the elevator controller entity 110, the controller entity 206 of the interface device 104 or any dedicated locally or remotely arranged device, such as a server device, configured to perform the tasks of the computing entity. The implementation of the computing entity may be done as a stand-alone entity or as a distributed computing environment between a plurality of stand-alone devices, such as a plurality of servers providing distributed computing resource in the elevator system 100.

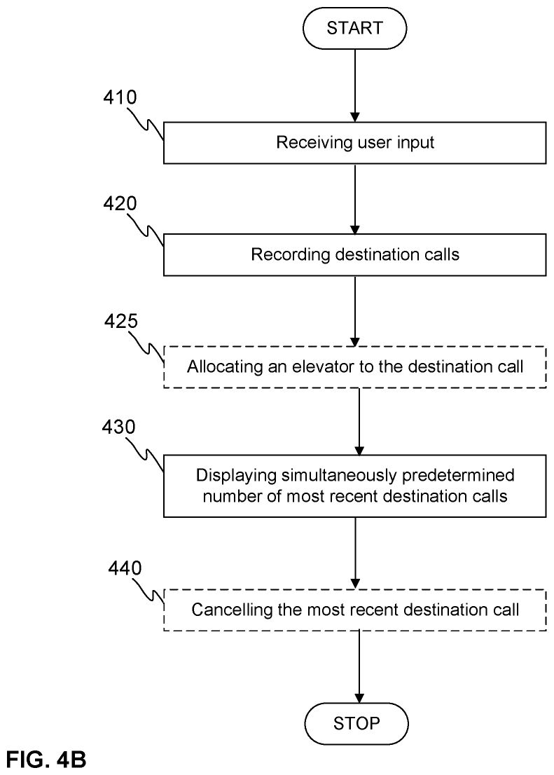

FIG. 4A schematically illustrates an example of the method for controlling displaying of a plurality of destination calls according to an embodiment of the invention. In step 410 the input means are configured to receive user input for making one or more destination calls. The user input may be received by several ways as discussed above. According to some non-limiting examples, the passenger may show an access device to the input means 202 of the interface device 104 or the passenger may use the touch screen of the input means 202 of the interface device 104 to input the input information, etc. In step 420 the controller entity 206 is configured to record the made destination calls. The recorded destination calls may be stored to the memory unit 320 of the interface device 104.

In step 430 the at least one display 204 of the interface device 104 is configured to display simultaneously said predetermined number of most recent destination calls made from said interface device 104 comprising the at least one display 204. The displayed destination call comprises at least the destination floor. The displayed destination call may further comprise departure floor, and/or state of the destination call. The state of the destination call may be for example at least one of the following: active, served, cancelled, missed elevator, etc. Active state means that the made destination call is at least recorded, but not served or cancelled. Served state means that the elevator has conveyed the passenger from the departure floor to the destination floor. Cancelled state means that the destination call is cancelled e.g. by the passenger. The missed elevator state means that the passenger has not taken the allocated elevator for some reason.

FIG. 4B schematically illustrates another example of the method for controlling displaying of a plurality of destination calls according to one embodiment. The controller entity 206 may further be configured to generate a control signal to the computing entity for allocating 425 an elevator to the made destination call and receive the allocation information of the made destination call. In case the elevator is allocated to the destination call, the displayed made destination call may further comprise allocation information of the destination call. The allocation information of the destination call may comprise an elevator ID indicating the currently allocated elevator 102a-102n to the destination call and/or guidance to the currently allocated elevator 102a-102n. The guidance may be for example an arrow pointing towards the allocated elevator.

According to one example, in case of the delayed DCS the allocation of the elevator to the destination call and/or displaying of the allocated elevator may be delayed as discussed above and the displayed destination call comprises only the destination floor. This enables that the elevator may be allocated later, or the allocated elevator may be changed, if some other elevator turns out to be able to serve the passenger before the initially allocated elevator. For example, if there becomes a failure to the elevator allocated for the destination call, another elevator may be allocated for said destination call.

According to one example, if the state of the destination call is missed elevator, i.e. the passenger has not taken for some reason the allocated elevator, the displayed destination call may comprise the state of the destination call and the interface device 104 may further prompt the passenger to make a new destination call. The state of the destination call may be defined to be missed elevator for example in response to that the input means 202 receives input information comprising passenger ID corresponding to a made destination call that is served at that time or is going to be served within a short time. Alternatively or in addition, the state of the destination call may be defined to be missed elevator for example in response to a detection that no one entered into the allocated elevator during a predetermined time and/or before a need for the next movement of the elevator car of said elevator 102a-102n. The detection may be based on information obtained from a scale or a curtain of light of said elevator 102a-102n.

FIGS. 5A-5C schematically illustrate examples of the interface device 104 comprising at least one display capable of displaying simultaneously a predetermined number of destination calls according to an embodiment of the invention. The example interface device 104 illustrated in FIGS. 5A-5C comprises a reader 202a, e.g. RFID reader, NFC reader, or QR code reader, that may interact with an access device in order to receive user input. The passenger may make a destination call by showing an access card to the reader 202a. In the examples illustrated in FIGS. 5A-5C the interface device 104 comprises further a touch screen 202b configured to receive user input. For example, the passenger may touch the touch screen on the area indicating one of the floors, such as floor 3 MEETING ROOMS, in order to make a destination call to said floor.

In the example illustrated in FIGS. 5A and 5B the at least one display is capable of displaying simultaneously two destination calls. In the example illustrated in FIG. 5A two most recent made destination calls are displayed on the display 204. The destination calls displayed on the display 204 comprises the destination floors, i.e. floor 12 to which the one of the most recent made destination calls is made and floor 21 to which to which the other one of the most recent destination calls is made.

FIG. 5B illustrates an example of the interface device 104, wherein a new, i.e. most recent, destination call (to floor 26) is made and in response to that the controller entity 206 of the interface device 104 records a new made destination call the at least one display 204 of the interface device 104 is configured to display the two most recent destination calls, which are in this case destination calls to the floor 21 and to the floor 26 (new most recent destination call). The destination calls displayed on the display 204 comprises the destination floors, i.e. floor 21 to which the one of the most recent destination calls is made and floor 26 to which the other one of the most recent destination calls is made.

FIG. 5C illustrates an example wherein the at least one display is capable of displaying simultaneously three destination calls. The destination calls displayed on the display 204 of the interface device 104 comprises the destination floors, i.e. floor 12 to which the one of the most recent destination calls is made, floor 21 to which to which other one of the most recent destination calls is made, and floor 26 to which yet other one of the most recent destination calls is made. Furthermore, in this example elevators are allocated for the destination calls and the destination calls displayed on the display 204 of the interface device 104 further comprise the currently allocated elevators 102a-102n, i.e. elevator C 102n allocated for the destination call to the floor 12, elevator A 102a allocated for the destination call to the floor 21, and elevator B 102b allocated for the destination call to the floor 26. Alternatively or in addition, the destination calls displayed on the display 204 may comprise a guidance to the allocated elevators 102a-102n. The guidance may be for example an arrow pointing towards the allocated elevator 102a-102n as illustrated in FIG. 5C.

In the examples illustrated in FIGS. 5A and 5B the destination calls are displayed next to each other and in the example illustrated in FIG. 5C the destination calls are displayed on top of each other. However, the invention is not limited to these examples, but the destination calls may be displayed on the at least one display 204 of the interface device 104 whichever way, e.g. in a form of a grid or matrix.

According to one embodiment, the input means 202 may further be configured to receive further user input comprising an instruction for cancelling the most recent destination call (optional step 440 illustrated in FIG. 4A). In response to receiving the cancelling instruction the controller entity 206 is configured to cancel the recorded most recent destination call. In case an elevator is allocated to the most recent destination call the controller entity 206 is further configured to provide the user input to the computing entity for cancelling the most recent destination call (optional step 440 illustrated in FIG. 4B). FIG. 6 illustrates schematically an example of the interface device 104 according to an embodiment of the invention, wherein the at least one display 204 and the input means 202 are implemented as common touch screen comprising an area indicating a button 202c, which the user may touch in order to provide user input comprising an instruction for cancelling the most recent destination call. The button 202c may be arranged in the vicinity of the most recent destination call, e.g. next to the most recent destination call as in the example illustrated in FIG. 6. However, the location of the button 202c in relation of the most recent destination call is not limited.

According to one embodiment, the input means 202 may be further configured to receive further user input comprising the passenger ID and the controller entity 206 of the interface device 104 is configured to retrieve from the memory unit 320 of the controller entity 206 already made destination call corresponding to the passenger ID of the received user input, i.e. the destination call is already at least made and possibly also an elevator is allocated for the made destination call corresponding to the passenger ID. The user input may be received by several ways as discussed above. According to some non-limiting examples, the passenger may show an access device to the input means 202 of the interface device 104 or the passenger may use the touch screen of the input means 202 of the interface device 104 to input the user input, etc. The at least on display 204 of the interface device 104 may be configured to display the destination call corresponding to the passenger ID of the received user input simultaneously with other destination call(s) if the destination call is among said predetermined number of most recent destination calls.

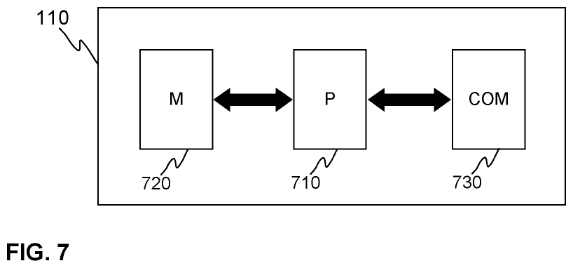

FIG. 7 schematically illustrates an example of an elevator controller entity 110. The elevator controller may comprise a processing unit 710 comprising one or more processors, a memory unit 720 comprising one or more memories, and a communication unit 730 comprising one or more communication devices, such as modems or other devices. The elevator controller entity 110 is configured to control the operation of the elevator, e.g. allocation of the elevator, etc., and to communicate at least with one or more interface devices 104, and/or on or more elevator entities 112 of the elevator system 100. The memory unit 720 may store portions of computer program code and any other data, and the processing unit 710 may cause the elevator controller entity 110 to operate as described by executing at least some portions of the computer program code stored in the memory unit 720.

The above described invention enables that a plurality of destination calls may be displayed simultaneously, which in turn allows that a new destination call may be made and/or displayed on the at least one display 204 of the interface device 104 simultaneously when the previously made destination call is still displayed on the at least one display 204 of the interface device 104. This reduces at least partly the waiting time and/or delay for providing a new destination call after the previous destination call. For example, if making a destination call takes approximately 1 second, the interface device 104 according to the present invention may serve approximately 1 second per passenger, whereas a prior art interface device that is capable of displaying only one destination call may serve approximately 3 to 6 seconds per passenger, because each destination call is displayed during 2 to 5 seconds one at a time. Furthermore, in the present invention additional actions, e.g. touching the touch screen of the interface device, by the next passenger are not needed to proceed with own destination call making process.

The term “destination call” refers throughout this application to a made destination call to which an elevator may be or may not be allocated.

The specific examples provided in the description given above should not be construed as limiting the applicability and/or the interpretation of the appended claims. Lists and groups of examples provided in the description given above are not exhaustive unless otherwise explicitly stated.

1. An interface device for controlling displaying of a plurality of destination calls, the device comprising:
input means configured to receive user input for making one or more destination calls;
a controller entity-POO configured to record made destination calls; and
at least one display capable of displaying simultaneously a predetermined number of destination calls, wherein the predetermined number is two or more, and
wherein the at least one display is configured to display simultaneously said predetermined number of most recent destination calls made from said interface device.

2. The interface device according to claim 1, wherein the displayed destination call comprises a destination floor.

3. The interface device according to claim 2, wherein the displayed destination call further comprises departure floor and/or state of the destination call.

4. The interface device according to claim 2, wherein the controller entity is further configured to:
generate a control signal to a computing entity for allocating an elevator to the made destination call; and
receive the allocation information of the made destination call,
wherein the displayed made destination call further comprises allocation information of the destination call.

5. The interface device according to claim 5, wherein the allocation information comprises an elevator ID of the elevator currently allocated to the destination call, and/or guidance to the elevator currently allocated to the destination call.

6. The interface device according to claim 4, wherein the computing entity is an elevator controller entity, the controller entity of the interface device, or any dedicated locally or remotely arranged device.

7. The interface device according to claim 1, wherein the interface device is a destination operation panel, DOP.

8. The interface device according to claim 1, wherein the at least one display is implemented as a dynamic header element.

9. The interface device according to claim 1, wherein the input means is at least one of the following: a card reader, RFID reader, QR code reader, a facial recognition camera, keypad, touch screen, a microphone for voice control, a camera for gesture control.

10. The interface device according to claim 1, wherein the input means is implemented as an external entity of the interface device communicatively coupled to the interface device.

11. The interface device according to claim 1, wherein the user input further comprises an instruction for cancelling the most recent destination call and the controller entity is configured to cancel the recorded most recent destination call.

12. The interface device according to claim 1, wherein the input means is further configured to receive further user input comprising the passenger ID, the controller entity is configured to retrieve from a memory unit of the controller entity already made destination call corresponding to the passenger ID of the received user input, and the at least on display is configured to display the destination call corresponding to the passenger ID of the received user input simultaneously with other destination call, if the destination call is among said predetermined number of most recent destination calls.

13. An elevator system comprising:
at least one elevator;
a computing entity; and
at least one interface device according to claim 1.

14. A method for controlling displaying of a plurality of destination calls, the method comprising:
receiving, by input means, user input for making one or more destination calls;
recording, by a controller entity, made destination calls; and
displaying, by at least one display capable of displaying simultaneously a predetermined number of destination calls, simultaneously said predetermined number of most recent destination calls,
wherein the predetermined number is two or more.

15. The method according to claim 14, wherein the displayed destination call comprises a destination floor.

16. The method according to claim 15, wherein the displayed destination call further comprises departure floor and/or state of the destination call.

17. The method according to claim 15, further comprising:
generating, by the controller entity, a control signal to a computing entity for allocating an elevator to the made destination call; and
receiving, by the controller entity, the allocation information of the made destination call,
wherein the displayed made destination call further comprises allocation information of the destination call.

18. The method according to claim 17, wherein the allocation information comprises an elevator ID of the elevator currently allocated to the destination call, and/or guidance to the elevator currently allocated to the destination call, an elevator ID, and/or guidance to the elevator.

19. The method according to claim 14, further comprising:
receiving, by the input means, user input comprising an instruction for cancelling the most recent destination call; and
cancelling, by the controller entity, the recorded most recent destination call.

20. The method according to claim 14, further comprising:
receiving, by the input means, further user input comprising the passenger;
retrieve, by the controller entity, already made destination call corresponding to the passenger ID of the received user input; and
displaying, by the at least on display, the destination call corresponding to the passenger ID of the received user input simultaneously with other destination calls, if the destination call is among said predetermined number of most recent destination calls.
